(19) United States
(12) Patent Application Publication
(10) Pub. No.: US 2023/0029055 A1
(43) Pub. Date: Jan. 26, 2023

(54) TRAVELING HISTORY REPORT OF PERSONAL WATERCRAFT

(71) Applicant: KAWASAKI MOTORS, LTD, Akashi-shi (JP)

(72) Inventors: Toshiyuki TSUBONE, Kobe-shi (JP); Shuichi MIYANISHI, Kobe-shi (JP); Tokishin NISHINAKA, Kobe-shi (JP); Nobuyuki NISHIGUCHI, Kobe-shi (JP)

(21) Appl. No.: 17/381,484

(22) Filed: Jul. 21, 2021

(51) Int. Cl. B63B 34/10; B63B 79/30; B63B 49/00; G01C 21/20

(52) U.S. Cl. CPC B63B 34/10; B63B 79/30; B63B 49/00; G01C 21/203

(57) ABSTRACT

A system for a traveling history report of a personal watercraft includes processing circuitry. The processing circuitry is configured to: generate traveling history data based on positional information indicating a position of the personal watercraft, the traveling history data including information indicating a movement route of the personal watercraft; and output the traveling history data.

### BACKGROUND OF THE INVENTION

### Field of the Invention

The present disclosure relates to a system, a server, and a method for a traveling history report of a personal watercraft.

### Description of the Related Art

Personal watercrafts (PWCs) that travel on water are known. The PWCs freely travel on the huge ocean where there are no definite roads and no landmarks.

### SUMMARY OF THE INVENTION

A system according to one aspect of the present disclosure includes processing circuitry. The processing circuitry is configured to: generate traveling history data based on positional information indicating a position of a personal watercraft, the traveling history data including information indicating a movement route of the personal watercraft; and output the traveling history data.

A server according to another aspect of the present disclosure includes processing circuitry. The processing circuitry is configured to: store pieces of traveling history data respectively including pieces of information indicating movement routes of personal watercrafts; receive a request signal; and transmit the pieces of traveling history data in accordance with the request signal to make a visual output device visually output superimposed display of the pieces of specific traveling history data.

A method according to yet another aspect of the present disclosure includes: generating traveling history data by processing circuitry based on positional information indicating a position of a personal watercraft, the traveling history data including information indicating a movement route of the personal watercraft; and outputting the traveling history data by the processing circuitry.

### BRIEF DESCRIPTION OF THE DRAWINGS

FIG. 1 is a side view of a personal watercraft.

FIG. 2 is a block diagram of a report system according to an embodiment.

FIG. 3 is a flow chart for explaining traveling history report extraction processing of the system of FIG. 2.

FIG. 4 is a flow chart for explaining traveling history report utilization processing of the system of FIG. 2.

FIG. 5 is a diagram showing a screen display image of a report unit of FIG. 2.

FIG. 6 is a diagram showing a screen display image of the report unit of FIG. 2.

FIG. 7 is a diagram showing a screen display image of the report unit of FIG. 2.

FIG. 8 is a diagram showing a screen display image of the report unit of FIG. 2.

### DESCRIPTION OF THE PREFERRED EMBODIMENTS

Hereinafter, an embodiment will be described with reference to the drawings.

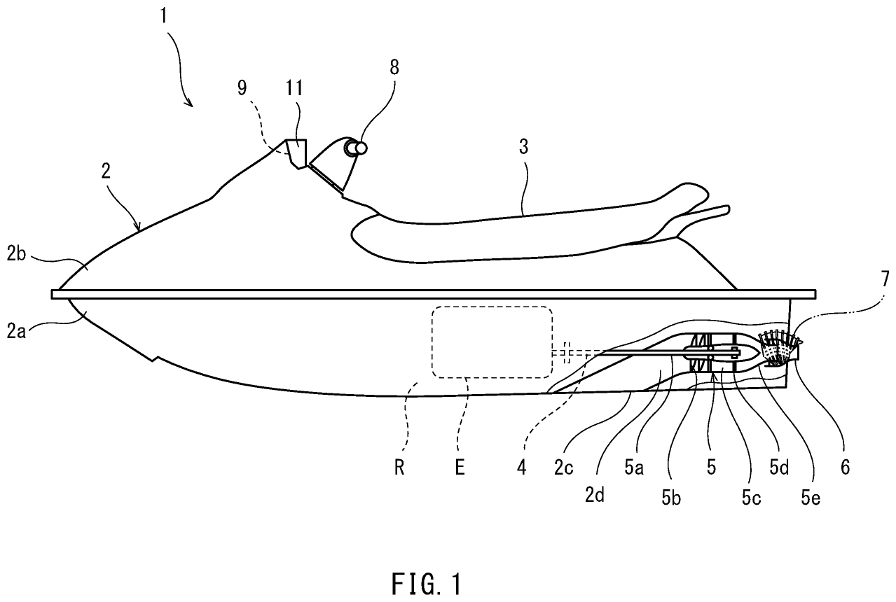

FIG. 1 is a side view of a personal watercraft 1. In the following description, the personal watercraft may be abbreviated as a PWC. As shown in FIG. 1, the PWC 1 includes a watercraft body 2. The watercraft body 2 includes a hull 2a and a deck 2b. The deck 2b covers the hull 2a from above. A seat 3 on which a user is seated is attached to the deck 2b. A prime mover room R is inside the watercraft body 11. A prime mover E is housed in the prime mover room R of the watercraft body 2. The prime mover E may be an internal combustion engine, an electric motor, or a combination of an internal combustion engine and an electric motor. An output shaft of the prime mover E is connected to a propeller shaft 4 extending rearward.

A water jet pump 5 is arranged at a rear portion of the hull 2a. The water jet pump 5 includes a pump shaft 5a, an impeller 5b, a stationary vane 5c, a pump casing 5d, and a pump nozzle 5e. The pump shaft 5a is coupled to a rear end portion of the propeller shaft 4. The impeller 5b is fixed to the pump shaft 5a. The stationary vane 5c is arranged behind the impeller 5b. The pump casing 5d covers the impeller 5b from an outside in a radial direction. The pump nozzle 5e is directed in a rear direction of the watercraft body 2.

A water intake port 2c is open at a bottom portion of the hull 2a. The water intake port 2c communicates with the pump casing 5d through a water intake passage 2d. A steering nozzle 6 is connected to the pump nozzle 5e of the water jet pump 5 so as to be swingable to left and right. A reverse bucket 7 is attached to the hull 2a. The reverse bucket 7 is pivotally supported by the hull 2a so as to be turnable between an advance position at which the reverse bucket 7 covers an ejection port of the steering nozzle 6 from behind to reverse ejected water from the steering nozzle 6 toward a front direction and a retreat position at which the ejection port of the steering nozzle 6 opens toward the rear direction.

The PWC 1 pressurizes and accelerates the water, taken in through the water intake port 2c of the bottom portion of the hull 2a, by rotational force of the impeller 5b of the water jet pump 5 driven by the prime mover E. The flow of this water is straightened by the stationary vane 5c and is ejected rearward from the pump nozzle 5e through the steering nozzle 6. Thus, propulsive force is generated. The PWC is not limited to a watercraft that is propelled on water by jet water flow generated by the water jet pump. The PWC may be a boat that is propelled on water by the rotation of a propeller.

A bar-shaped handle 8 supported by the deck 2b so as to be turnable is arranged at an upper side of a front portion of the deck 2b. When a rider of the PWC 1 tilts the handle 8 to the left or the right, the steering nozzle 6 swings to the left or the right in accordance with the tilting. During normal driving, the handle 8 is manually turned by hands of the rider. During automatic driving, the handle 8 is automatically turned by a steering actuator.

Since the PWC 1 travels on water, the degree of freedom of route selection is higher than that of road traveling. In the present embodiment, the PWC 1 includes a report unit 11 that generates traveling history data including information indicating a movement route of the PWC 1. With this, the rider of the PWC 1 can easily recognize and trace the movement route based on the traveling history. In the present embodiment, the report unit 11 is located in front of the seat 3. In the present embodiment, the report unit 11 serves as at least a part of a report system 10. More specifically, the report unit 11 is detachably attached to a unit support 9 of the PWC 1. The unit support 9 is arranged in front of the handle 8, outside a movable range of the handle 8, and above an upper surface of the seat 3.

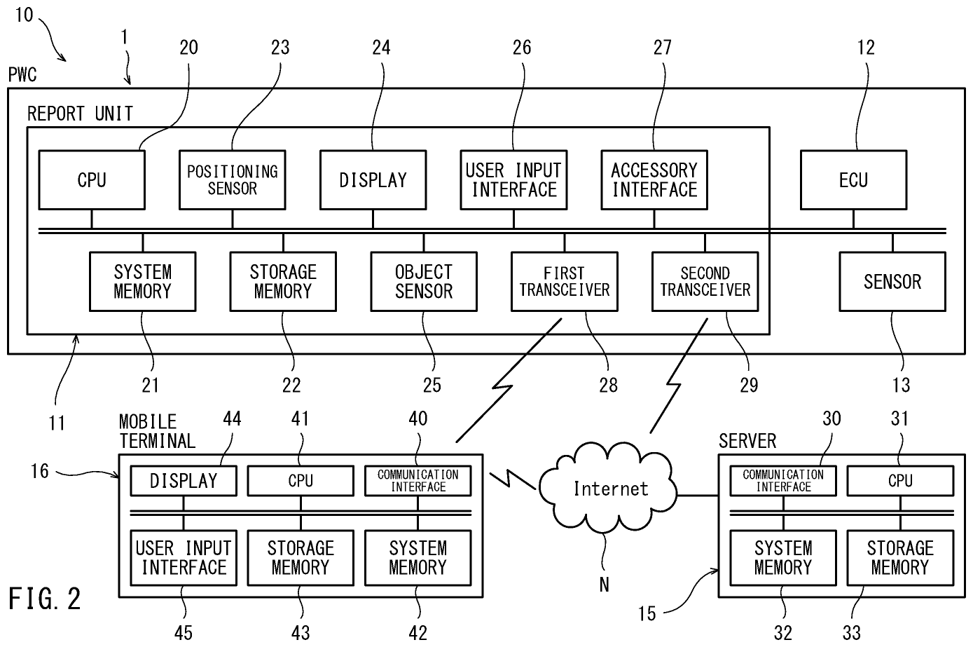

FIG. 2 is a block diagram of the report system 10 according to the embodiment. As shown in FIG. 2, the report system 10 includes: at least one memory that stores a traveling history report program; and at least one processor that can execute the traveling history report program. For example, the report system 10 includes the report unit 11.

The report unit 11 includes: a memory that stores a traveling history extraction program and a traveling history utilization program; and a processor that can execute the traveling history extraction program and the traveling history utilization program. The traveling history extraction program and the traveling history utilization program constitute part of the traveling history report program. Specifically, the report unit 11 includes a CPU 20, a system memory 21, a storage memory 22, a positioning sensor 23, a display 24, an object sensor 25, a user input interface 26, an accessory interface 27, a first transceiver 28, a second transceiver 29, and the like. The report unit 11 includes a clock therein. The display 24 is one example of a visual output device. A printer as the visual output device may be connected to the report unit 11.

The CPU 20 is a central processing unit. The system memory 21 may include a RAM. The storage memory 22 is one example of a computer-readable medium and is a non-transitory, tangible medium. The storage memory 22 may include a ROM. The storage memory 22 may include a hard disk, a flash memory, or a combination thereof. The storage memory 22 stores the traveling history extraction program and the traveling history utilization program. A configuration in which the CPU 20 executes the traveling history extraction program and the traveling history utilization program read by the system memory 21 is one example of processing circuitry.

The positioning sensor 23 is a sensor that detects current position coordinates of the PWC 1. The positioning sensor 23 may be a satellite positioning sensor, such as a GPS sensor. The current position coordinates of the PWC 1 may be obtained by calculation based on a movement distance calculated from a traveling speed and a movement direction calculated from acceleration.

The display 24 is a type of interface that performs output to a user. The display 24 may be a display device, such as a liquid crystal display, an organic EL display, an AR (Augmented Reality) display, a head mount display, or a LED.

The object sensor 25 is a sensor that acquires position related data related to a positional relation between the PWC 1 and a peripheral object that is a tangible object around the PWC 1. The object sensor 25 may be a sensor that detects the peripheral object by an electromagnetic wave, a sound wave, and/or light. The object sensor 25 may be a sonar, a radar sensor, a camera, or the like.

The user input interface 26 is an interface which is manipulated by a user and to which information is input. The user input interface 26 may be a touch panel of the display 24, a button, a lever, or the like.

An external device as an accessory is detachably connectable to the accessory interface 27. The accessory interface 27 is, for example, a communication cable port. For example, an external camera or an external sensor may be electrically connected to the accessory interface 27 through a communication cable. To be specific, the report unit 11 and an external electronic device can mutually perform information exchange through the accessory interface 27.

The first transceiver 28 performs wireless communication directly with a mobile terminal 16, such as a smartphone or a smart watch, without through a base station. The first transceiver 28 may perform wireless communication with the mobile terminal 16 by near field communication, such as Bluetooth or Wi-Fi. A radio wave transmission/reception range of the first transceiver 28 is set to, for example, less than 10 meters. The mobile terminal 16 includes a processor and a memory. The mobile terminal 16 is disposed at the PWC 1 or carried by the rider of the PWC 1 so as to move together with the PWC 1. The mobile terminal 16 is wirelessly connected to a network N, such as the Internet, through a public line and can communicate with a server 15. The mobile terminal 16 may be physically and electrically connected to the report unit 11 through a cable. Part of the mobile terminal 16 or the entire mobile terminal 16 may constitute part of the report system 10.

The server 15 includes a processor and a memory. Specifically, the server 15 includes a communication interface 30, a CPU 31, a system memory 32, a storage memory 33, and the like. The communication interface 30 is, for example, a communication board connected to the network N by a cable. The CPU 31 is a central processing unit. The system memory 32 may include a RAM. The storage memory 33 is one example of a computer-readable medium and is a non-transitory, tangible medium. The storage memory 33 may include a ROM. The ROM stores identification information of the PWC 1. The storage memory 33 may include a hard disk, a flash memory, or a combination thereof. The storage memory 33 stores a traveling history report distribution program. The traveling history report distribution program constitutes part of the traveling history report program. A configuration in which the CPU 31 executes the traveling history report distribution program read by the system memory 32 is one example of the processing circuitry. A storage area that stores traveling history information may be formed in the storage memory 22.

The mobile terminal 16 includes a processor and a memory. Specifically, the mobile terminal 16 includes a communication interface 40, a CPU 41, a system memory 42, a storage memory 43, a display 44, a user input interface 45, and the like. The communication interface 40 is a wireless communication device that is wirelessly connected to the network N. The CPU 41 is a central processing unit. The system memory 42 may include a RAM. The storage memory 43 is one example of a computer-readable medium and is a non-transitory, tangible medium. The storage memory 43 may include a ROM. The storage memory 43 may include a hard disk and/or a flash memory.

The display 44 is a type of interface that performs output to a user. The display 44 may be a display device, such as a liquid crystal display or an organic EL display. The user input interface 45 is an interface which is manipulated by a user and to which information is input. The user input interface 45 may be a touch panel of the display 44, a button, or the like. The storage memory 43 stores the traveling history report utilization program. The traveling history report utilization program constitutes part of the traveling history report utilization program. A configuration in which the CPU 41 executes the traveling history report utilization program read by the system memory 42 is one example of the processing circuitry.

The second transceiver 29 can communicate with the server 15 by being wirelessly connected to the network N, such as the Internet, through a public line. To be specific, the report unit 11 may be connected to the network N through the mobile terminal 16 or may be directly connected to the network N by the second transceiver 29. The mobile terminal 16 and the first transceiver 28 may be omitted, or the second transceiver 29 may be omitted. The report unit 11 may include a transceiver that performs wireless communication directly with other communication devices by RF (Radio Frequency) communication or the like without through the base station. The report unit 11 does not have to include the first transceiver 28 and the second transceiver 29.

The report unit 11 may record the traveling history data in the storage memory 22 of the report unit 11 without being connected to the network N, and the traveling history data may be written in a portable memory and carried. The report unit 1 may allow a user to select whether to upload the traveling history data to the server 15 or to locally store the traveling history data in the storage memory 22 or the portable memory.

In addition to the report unit 11, the PWC 1 includes an ECU (Electronic Control Unit) 12, a sensor 13, and the like. The ECU 12 is a prime mover controller that includes a processor and a memory and controls the prime mover E based on a signal of the sensor 13. The sensor 13 may include: an accelerator sensor that detects a required acceleration amount of the rider of the PWC 1; a rotational frequency sensor that detects a rotational frequency of the prime mover E; a remaining amount sensor that detects a remaining amount of an energy source, such as fuel or a battery; a speed sensor that detects a traveling speed of the PWC 1; an acceleration sensor that detects acceleration of the PWC 1; a gyro sensor that detects a posture of the PWC 1; an inertial measurement unit (IMU) that measures an angular speed and acceleration of the PWC 1; a sensor that detects a state of the reverse bucket 7; a rear view camera; a front view camera; a temperature sensor that detects an ambient air temperature or an ambient water temperature; a sensor that acquires weather; a sensor that acquires date and time; or any combination thereof. When the prime mover E is an internal combustion engine, the sensor 13 may include: an engine sensor that detects a state (for example, a rotational frequency or a warning state) of the engine; an 02 sensor that detects an exhaust state; an intake pressure sensor that detects intake pressure; and the like.

The ECU 12 and the sensor 13 are connected to each other through a CAN (Controller Area Network) communication line, and the report unit 11 is connected to the CAN communication line. The report unit 11 may include an interface, such as a USB connector or a wireless transceiver, which is used to output the traveling history data.

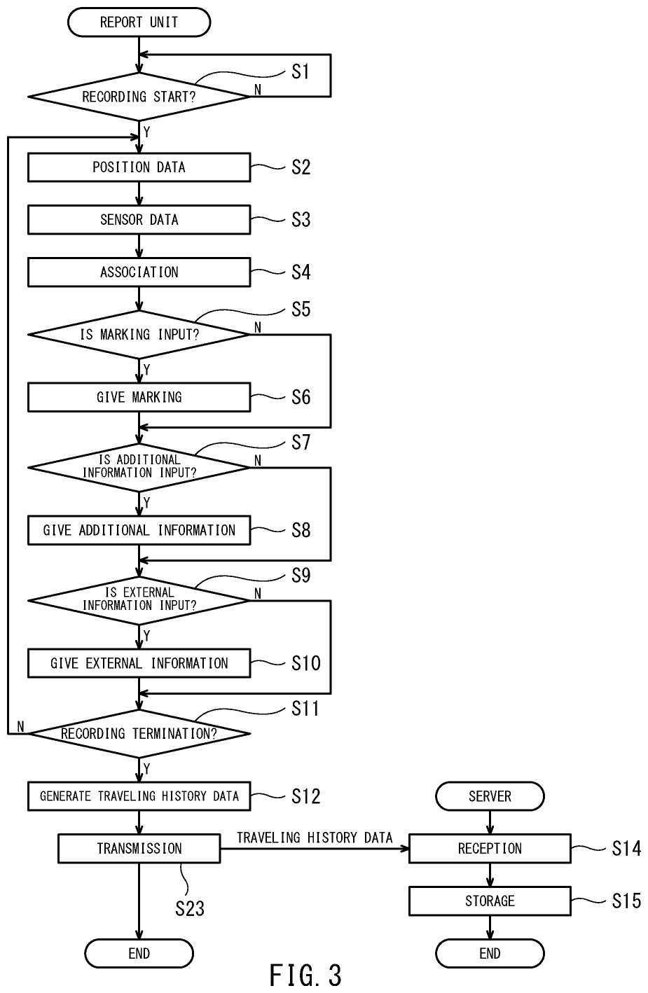

FIG. 3 is a flow chart for explaining traveling history report extraction processing of the system of FIG. 2. The following will be described based on the flow of FIG. 3 with suitable reference to FIG. 2. The CPU 20 of the report unit 11 determines whether or not a recording start of a traveling history report has been instructed by the manipulation of the user input interface 26 by the rider of the PWC 1 (Step S1). When the recording start has been instructed (Yes in Step S1), the CPU 20 acquires positional information indicating the current position coordinates of the PWC 1 detected by the positioning sensor 23 (Step S2) and acquires sensor data from the sensor 13 and the object sensor 25 (Step S3).

The CPU 20 associates the current position coordinates of the PWC 1 with the sensor data and stores the current position coordinates of the PWC 1 and the sensor data as the traveling history data in the storage memory 22 (Step S4). The traveling history data may include the identification information of the PWC 1 and rider information input through the user input interface 26. The sensor data associated with the current position coordinates of the PWC 1 may include the speed of the PWC 1 and a PWC posture of the PWC 1 as data indicating behavior of the PWC 1. The PWC posture includes a pitch angle, a roll angle, a yaw angle, or any combination thereof. The sensor data associated with the current position coordinates of the PWC 1 may include upward and downward acceleration, angular speed, or a combination thereof.

The sensor data associated with the current position coordinates of the PWC 1 may include an accelerator manipulation amount, a reverse bucket manipulation amount, and the like as data indicating manipulation amounts regarding driving manipulation of a user. The sensor data associated with the current position coordinates of the PWC 1 may include the rotational frequency of the prime mover E, the remaining amount of the energy source such as fuel or a battery, and the like as data indicating the states of the PWC 1. The sensor data associated with the current position coordinates of the PWC 1 may include the position related data related to the positional relation between the PWC 1 and the peripheral object around the PWC 1. The position related data may include, for example, a distance from the PWC 1 to the peripheral object and/or a direction from the PWC 1 to the peripheral object. For example, the peripheral object may be a water bottom, an obstacle, or another PWC. The position related data may be a distance from the PWC 1 to the water bottom in an upper-lower direction or a distance to another PWC.

The object sensor 26 may be a sensor that detects the peripheral object as the tangible object by an electromagnetic wave, a sound wave, light, or any combination thereof. The object sensor 26 may be a sonar, a radar sensor, a camera, an infrared sensor, or a RFID sensor. For example, the sonar may detect a distance from the PWC 1 to the water bottom and a direction of the water bottom by receiving a reflected wave that is the sound wave output downward to the water bottom and then reflected by the water bottom. The radar sensor may detect a distance from the PWC 1 to the peripheral object and a direction of the peripheral object by receiving a reflected radio wave that is an output radio wave reflected by the peripheral object. The camera may detect the distance from the PWC 1 to the peripheral object and the direction of the peripheral object by taking an image of the periphery of the PWC 1 and recognizing the peripheral object in the image by image processing. The infrared sensor may detect the distance from the PWC 1 to the peripheral object and the direction of the peripheral object by detecting a human by a temperature. The RFID sensor may detect the presence of a human in a predetermined range by detecting a RFID tag carried by the human by RFID communication.

The report unit 11 of the PWC 1 may acquire the positional information of a PWC 2 detected by a positioning sensor of the PWC 2 by communication of a RF (Radio Frequency) communication transceiver mounted on the PWC 1 with a RF communication transceiver mounted on the PWC 2. The position related data related to the positional relation between the PWC 1 and the peripheral object around the PWC 1 may include position related data between the PWC 1 and the PWC 2. The position related data may be related to a relative positional relation between the PWC 1 and the PWC 2.

The CPU 20 determines whether or not a user's input of marking information has been received (Step S5). When it is determined that the rider of the PWC 1 has manipulated the user input interface 26 to input the marking information (Yes Step S5), the CPU 20 associates the marking information with the current position coordinates as a specific location and stores the marking information (Step S6). The marking information is information in which a favorite location is marked and which is utilized to facilitate revisit to the favorite location.

The CPU 20 determines whether or not an input of additional information associated with the current position coordinates has been received (Step S7). When it is determined that the additional information has been input (Yes in Step S7), the CPU 20 associates the additional information with the current position coordinates as the specific location and stores the additional information (Step S8). The additional information may be input automatically or manually. The additional information input automatically may be warning information. The warning information includes, for example, shallow place information, obstacle information, capsizing information, PWC abnormality warning information, or the like. Each of the shallow place information and the obstacle information may be information indicating that the distance from the PWC 1 to the water bottom or the obstacle detected by the object sensor 25 is less than a predetermined value. The capsizing information may be information indicating that a predetermined time has elapsed since the PWC 1 has become a capsizing posture. The PWC abnormality warning information is information indicating that an abnormality which lights a warning lamp in a meter of the PWC 1 has occurred. For example, the PWC abnormality warning information may include driving abnormality of the prime mover E, abnormality of a sensor, abnormality of a wire, abnormality of an electronic part, or the like. The additional information input manually may be reference information. The reference information may be peripheral information, such as fish-catch information, scenery information, or coral information. The additional information input manually may be, for example, text information input by the rider of the PWC 1 through the user input interface 26 or voice information recorded through a microphone.

The CPU 20 determines whether or not the input of external information associated with the current position coordinates has been received (Step S9). The external information is input by utilizing the accessory interface 27, the first transceiver 28, or the like. When it is determined that the external information has been input (Yes in Step S9), the CPU 20 associates the external information with the current position coordinates as the specific location and stores the external information (Step S8). The external information is, for example, image information or video information. The image information and the video information may be input from an accessory device, such as a camera, connected to the accessory interface 27 or may be input from the mobile terminal 16 through the first transceiver 28.

The CPU 20 determines whether or not a recording termination of the traveling history report has been instructed by the manipulation of the user input interface 26 by the rider of the PWC 1 (Step S11). When the recording termination has not yet been instructed (No in Step S11), the CPU 20 returns to Step S2 and repeats the processing to continuously accumulate various data in the storage memory 22. When the recording termination has been instructed (Yes in Step S11), the CPU 20 generates the traveling history data (Step S12).

The traveling history data includes data of time-series position coordinates of the PWC 1 in a period from the recording start until the recording termination. Therefore, the movement route of the PWC 1 is indicated by the data of the time-series position coordinates. The traveling history data includes the position coordinates and the sensor data which are associated with each other and may further include the marking information, the additional information, the external information, and the like. The traveling history data may include the identification information of the PWC 1 or the identification information of the report unit 11. The traveling history data may include: user information, such as the sex, age, preference, etc. of the user of the PWC 1; model information of the PWC 1; and number-of-occupants information of the PWC 1. The traveling history data may include time period information corresponding to a time from the recording start until the recording termination.

The CPU 20 transmits the generated traveling history data to the server 15 through the first transceiver 28 or the second transceiver 29 (Step S13). When the second transceiver 29 or the communication interface 40 is located outside a wireless communication range at the time of this transmission, the CPU 20 stands by until the second transceiver 29 or the communication interface 40 enters the wireless communication range. The transmission of the traveling history data from the report unit 11 or the mobile terminal 16 to the server 15 may be performed automatically or may be performed based on reception of a user's command.

The server 15 receives through the communication interface 30 the traveling history data transmitted from the report unit 11 (Step S14). The CPU 31 of the server 15 stores the received traveling history data in the storage memory 33. Similarly, the server 15 receives and stores the traveling history data from the report units 11 of other PWCs different from the PWC 1, and therefore, accumulates a large number of pieces of traveling history data.

The server 15 may acquire information regarding environment from another server based on the time period information included in the traveling history data and may associate the acquired information regarding the environment with the traveling history data. The information regarding the environment may include the rise and fall of the tide, tidal current, a wind direction, a wind speed, an air temperature, a water temperature, weather, or any combination thereof. Among the information regarding the environment, the report unit 11 of the PWC 1 may acquire information (such as air temperature, water temperature, humidity, and air pressure), which can be acquired by the sensor 13 of the PWC 1, from the sensor 13 of the PWC 1 instead of acquiring such information from the server 15.

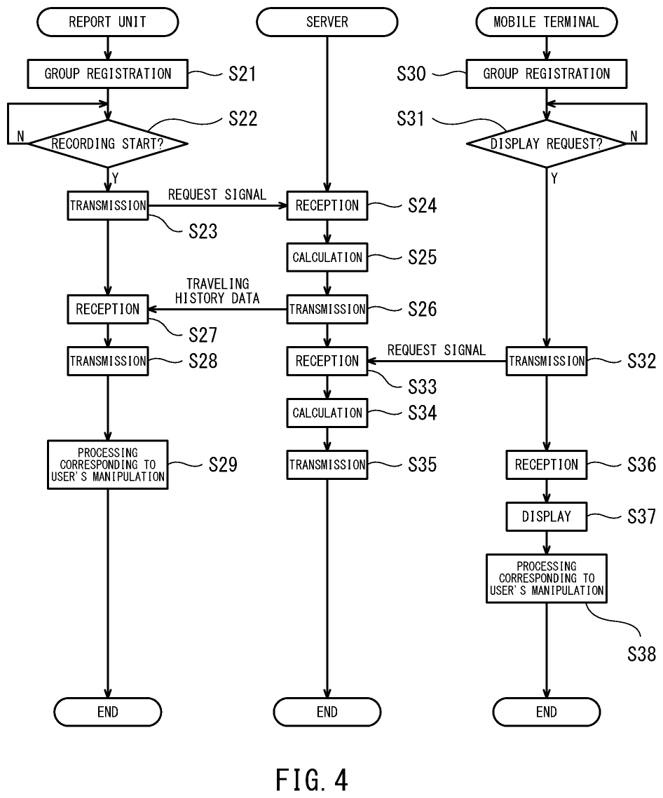

FIG. 4 is a flow chart for explaining traveling history report utilization processing of the system of FIG. 2. As shown in FIG. 4, the CPU 20 of the report unit 11 displays a user input screen image on the display 24 in accordance with predetermined input manipulation and stands by for a user's input of a command of registering one or more other PWCs as specific PWCs. The user manipulates the user input interface 26 of the report unit 11 to input the registration of the specific PWC (Step S1). The CPU 20 stores the information of the registered specific PWC in the storage memory 22. Step S21 may be executed at any timing corresponding to a user's request. Step S21 may be omitted.

Regarding Step S21, the report unit 11 may receive a user's input such that the specific PWCs can be registered by being divided into groups, and may associate the specific PWCs with the corresponding groups and store the specific PWCs in the storage memory 22. When the CPU 20 displays the user input screen image on the display 24, the CPU 20 may receive a user's input of a command of registering a communication device of a vehicle other than the PWC, a mobile communication device of a specific user, a communication device of a predetermined manager, or the like as a specific communication target and may store the specific communication target in the storage memory 23.

The CPU 20 of the report unit 11 determines whether or not a display request of requesting visual display of the traveling history data has been input by the user through the user input interface 26 (Step S22). When it is determined that the display request has been input, the CPU 20 transmits a request signal to the server 15 through the first transceiver 28 or the second transceiver 29 (Step S23).

There are various display requests input by the user. The display request may include the identification information of the PWC 1. The display request may be a request of displaying a piece of past traveling history data of the user or pieces of traveling history data of the user. The display request may be a request of displaying a piece of traveling history data of another person or pieces of traveling history data of another person. The display request may be a request of displaying both the past traveling history data of the user and the traveling history data of another person. The display request may be a request of displaying the traveling history data of the registered specific PWC. The display request may be a request of displaying the traveling history data of the specific PWC belonging to the registered group. The display request may be a request of displaying the traveling history data indicating a movement route included in a geographical specific area. The specific area may be specified by the user through the user input interface 26 or may be set as a predetermined range based on a current position of the PWC 1 detected by the positioning sensor 23.

The server 15 receives the request signal through the communication interface 30 (Step S24). The CPU 31 of the server 15 extracts, as specific traveling history data, one or more pieces of corresponding traveling history data from the storage memory 33 in accordance with the contents of the display request included in the request signal (Step S25). To be specific, in accordance with the contents of the request signal, the server 15 performs screening of a large number of pieces of traveling history data accumulated in the storage memory 33 and extracts the specific traveling history data corresponding to the request. The server 15 may extract the past traveling history data based on the identification information of the PWC 1 included in the request signal. With this, the user of the PWC 1 can extract the traveling history data of the own watercraft. The server 15 may extract the traveling history data by using a traveling area, a traveling time, a traveling season, or any combination thereof as a screening condition. With this, a traveling route can be planned based on the traveling history data related to traveling under the same condition. The server 15 may extract the traveling history data including the warning information. With this, the traveling route which avoids a situation in which abnormality has occurred in the past can be planned.

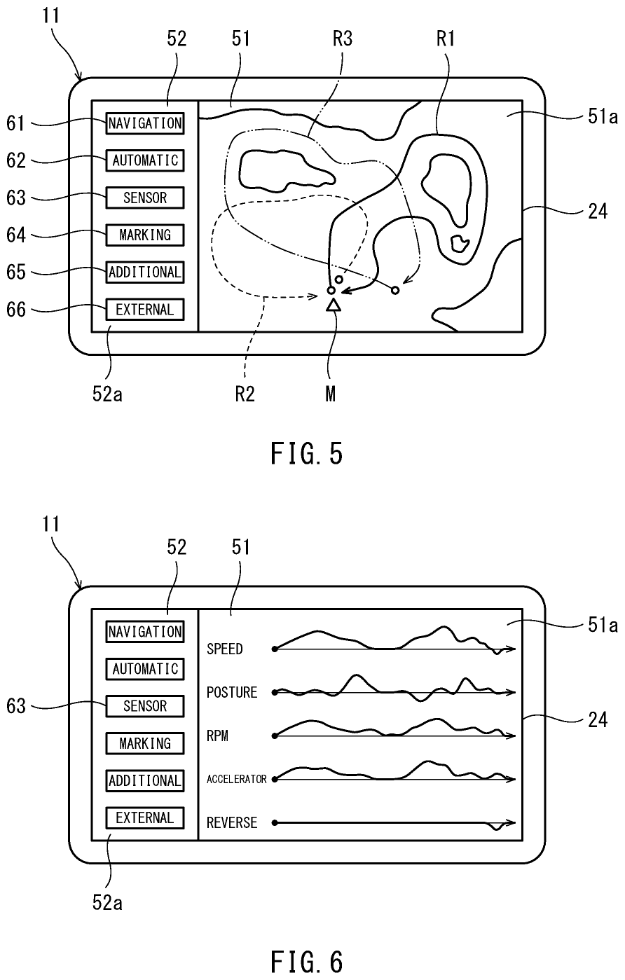

The CPU 31 transmits one or more pieces of extracted specific traveling history data to the report unit 11 (Step S26). The report unit 11 receives the one or more pieces of extracted specific traveling history data from the server 15 (Step S27). The CPU 20 of the report unit 11 displays the received traveling history data on the display 24 (Step S28). FIG. 5 shows one example of a display screen image of the received specific traveling history data. As shown in FIG. 5, the display screen image includes a main region 51 and a sub region 52. The main region 51 displays, for example, a map screen image 51a. The map screen image 51a may display a current place mark M indicating a current place of the PWC 1 on a map.

When pieces of specific traveling history data are received from the server 15, the map screen image 51a performs superimposed display of movement routes R1-R3 on the map screen image, the movement routes R1-R3 being respectively indicated by the pieces of specific traveling history data. In this case, the map screen image 51a displays a traveling history map generated by assembling traveling histories. The movement route R1 may be a past movement route of the PWC 1, and the movement routes R2 and R3 may be past movement routes of another PWC or other PWCs. The movement routes R1-R3 may be past movement routes of the PWC 1 or may be movement routes of another PWC or other PWCs. When only one piece of specific traveling history data is received from the server 15, the map screen image 51a may display only one movement route. The movement routes R1-R3 may be past movement routes of the registered specific PWC or PWCs. The movement routes R1-R3 may be past movement routes of the specific PWC or PWCs belonging to the registered group.

As in various examples described below, the CPU 20 of the report unit 11 performs processing corresponding to user's manipulation (Step S29). For example, when the user selects one of the movement routes R1-R3 on the map screen image 51a, pop-up display of attribute information of the selected movement route is performed. For example, the attribute information may include user information (such as sex, age, and preference) regarding the user of the PWC which has traveled the selected movement route, model information of the PWC which has traveled the selected movement route, number-of-occupants information when the PWC has traveled the selected movement route, time period information when the PWC has traveled the selected movement route, or environment information when the PWC has traveled the selected movement route. The attribute information of the movement route may be displayed before the movement route is selected.

The sub region 52 displays, for example, a manipulation screen 52a. The manipulation screen 52a displays a navigation command section 61, an automatic traveling command section 62, a sensor data display command section 63, a marking information display command section 64, an additional information display command section 65, and an external information display command section 66. When one of the movement routes R1-R3 is selected, and the user selects the navigation command section 61, the CPU 20 of the report unit 11 starts navigation that guides the PWC 1 to the selected movement route. When one of the movement routes R1-R3 is selected, and the user selects the automatic traveling command section 62, the CPU 20 transmits a control signal to the ECU 12 of the PWC 1 to make the ECU 12 automatically control the prime mover E and the handle 8 such that the PWC 1 automatically travels along the selected movement route.

As shown in FIG. 6, when one of the movement routes R1-R3 is selected, and the user selects the sensor data display command section 63, the main region 51 displays a sensor data screen image 51b. The sensor data screen image 51b displays the PWC speed, the PWC posture, the prime mover rotational frequency, the accelerator manipulation amount, the reverse bucket manipulation amount, and the like, which are included in the traveling history data corresponding to the selected movement route, in association with positions or times. Items displayed on the sensor data screen image 51b are not limited to those and may include a remaining amount of an energy source such as fuel or a battery, a distance from a PWC to a water bottom, a distance to another PWC, and the like.

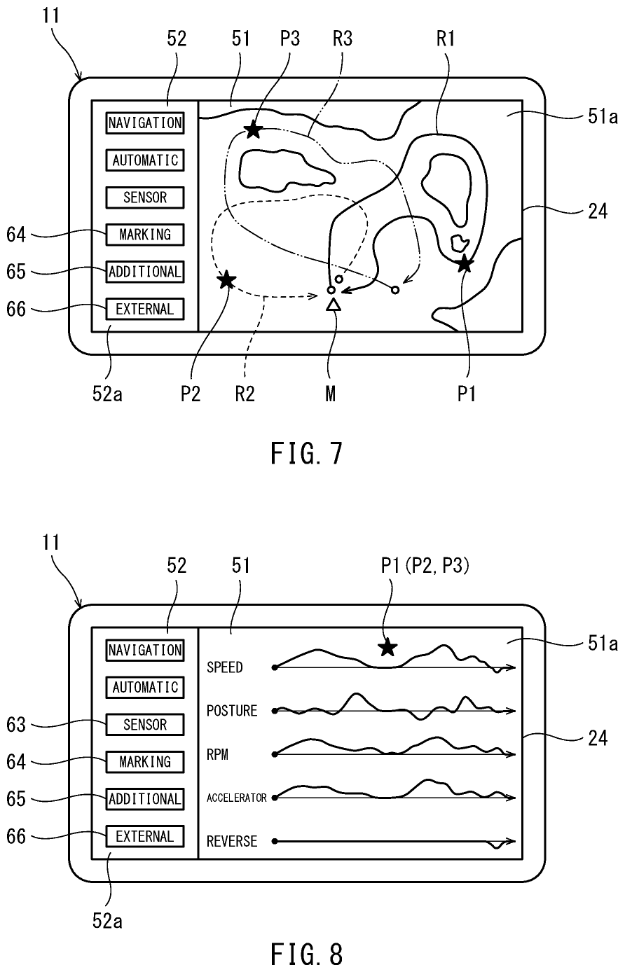

As shown in FIG. 7, when the map screen image 51a is displayed, and the user selects the marking information display command section 64, the CPU 20 displays on the map screen image 51a a reference mark P1 indicating a spot where the marking information associated with the movement route R1, R2, R3 is registered. When the user selects the additional information display command section 65, the CPU 20 displays on the map screen image 51a a reference mark P2 indicating a spot where the additional information associated with the movement route R1, R2, R3 is registered. When the user selects the reference mark P2, pop-up display of the additional information corresponding to the selected reference mark P2 is performed. When the user selects the external information display command section 66, the CPU 20 displays on the map screen image 51a a reference mark P3 indicating a spot where the external information associated with the movement route R1, R2, R3 is registered. When the user selects the reference mark P3, pop-up display of the external information corresponding to the selected reference mark P3 is performed.

As shown in FIG. 8, the reference marks P1-P3 may be displayed on the sensor data screen image 51b. When the sensor data screen image 51b is displayed, and the user selects the marking information display command section 64, the CPU 20 displays on the sensor data screen image 51b the reference mark P1 indicating a point where the marking information associated with the movement route corresponding to the displayed sensor data is registered. When the user selects the additional information display command section 65, the CPU 20 displays on the sensor data screen image 51b the reference mark P2 indicating a point where the additional information associated with the movement route is registered. When the user selects the reference mark P2, pop-up display of the additional information corresponding to the selected reference mark P2 is performed. When the user selects the external information display command section 66, the CPU 20 displays on the sensor data screen image 51b the reference mark P3 indicating a point where the external information associated with the movement route is registered. When the user selects the reference mark P3, pop-up display of the external information corresponding to the selected reference mark P3 is performed.

The foregoing has described an example in which the traveling history report utilization processing is executed by using the report unit 11. However, the traveling history report utilization processing may be executed by using the mobile terminal 16. To be specific, as shown in FIG. 4, the mobile terminal 16 and the server 15 may execute Steps S30-S38 similar to Steps S21-S29 described above. The report unit 11 and the mobile terminal 16 may visually output the specific traveling history data by printing the specific traveling history data by a printer instead of visually outputting the specific traveling history data by displaying the specific traveling history data on a display.

The report unit 11 may output the traveling history data at a predetermined timing, such as at the time of the termination of the traveling for each day. Specifically, the report unit 11 may make the printer print out the traveling history data or may store the traveling history data in an external memory detachable from the PWC 1. With this, the rider of the PWC 1 can see the printed traveling history data after the driving or can see the traveling history data stored in the external memory by a personal computer after the driving. Thus, even after the rider leaves the PWC 1, the rider can confirm the traveling history anytime, anywhere.

In order that the user of the PWC 1 improves his/her sport riding techniques, the user of the PWC 1 can compare the traveling history data of the own watercraft with the traveling history data of another watercraft. The user of the PWC 1 can improve the riding techniques by trying to perform such driving manipulation as to trace the movement route indicated by the traveling history data of an expert. In this case, it is preferable that in the traveling history data, details of information related to the driving manipulation be confirmable. For example, it is preferable that the traveling history data include information regarding the driving manipulation for each traveling route (for example, the accelerator manipulation amount, a time change of accelerator manipulation, weight shift (roll posture, pitch posture), a traveling speed, and the like).

The traveling history data may include three-axis direction accelerations detected by the IMU. With this, a collision position and a collision degree when the PWC 1 collides with a reef can be determined from the traveling history data. Thus, whether or not the impact is predetermined impact or more can be confirmed by checking the traveling history data after the traveling, and this can be utilized for the maintenance of the PWC 1. A traveling region where impact to the watercraft body or damage of the watercraft body tends to occur can be recognized beforehand by checking the traveling history data.

Blocks shown in the flow charts of FIGS. 3 and 4 in order may be executed at the same time or may be executed in reverse order in some cases. The program of the report unit 11 may be executed partially or entirely by the mobile terminal 16. The traveling history extraction program may be executed partially or entirely by the mobile terminal 16 instead of the report unit 11. The traveling history extraction program or the traveling history utilization program may be executed partially or entirely by the ECU 12 of the PWC 1.

According to the above-described configuration, the past movement routes R1-R3 can be recognized by utilizing the traveling history data. For example, support for the reproduction of the traveling along the past movement routes R1-R3 is realized.

When the traveling history data includes the identification information associated with the PWC, the rider who traveled each of the movement routes R1-R3 can be easily recognized.

When the traveling history data includes the time period information regarding a time period in which the PWC moves along each of the movement routes R1-R3, the environmental information, such as weather, can be associated with the movement route based on the time period information, and therefore, the report can be improved.

When the specific traveling history data received from the server 15 storing pieces of traveling history data is displayed on the display 24 or 44, the past movement routes R1-R3 can be seen by utilizing the traveling history data stored in the server 15.

When the superimposed display of the movement routes R1-R3 indicated by the pieces of specific traveling history data is performed on the map screen image 51a, the traveling history map generated by assembling the traveling histories can be provided. Therefore, the past movement routes R1-R3 can be visually and easily compared with each other, and the determination of the future movement route can be supported.

When the traveling history data corresponding to the specific PWC belonging to the group is displayed on the display 24 or 44, the past movement routes R1-R3 of a registered group member can be seen. Thus, information sharing among the group members can be realized, and therefore, pleasure can be increased.

When the traveling history data includes the additional information associated with the specific location in the movement route R1, R2, or R3, the location with which the additional information is associated can be recognized, and this can be utilized for the determination of the future movement route.

When the traveling history data includes the marking information associated with the specific location in the movement route R1, R2, or R3, the favorite location can be marked, and the revisit to the location can be made easy.

When the traveling history data includes the image information associated with the movement route R1, R2, or R3, a scenery image, a fish finder image, or the like in the movement route can be recognized, and this can be utilized for the determination of the future movement route.

When the control signal which makes the PWC automatically travel along the movement route R1, R2, or R3 is generated based on the traveling history data, the reproduction of the traveling along the past movement route can be realized regardless of the technique of the user.

When the traveling history data includes the behavior information indicating the behavior of the PWC, the report can be improved.

When the behavior information includes information indicating the speed or posture of the PWC, differences from the behavior of another PWC can be recognized by the report.

When the traveling history data includes information indicating the manipulation amount regarding the driving manipulation, such as accelerating or steering of the user, differences from the driving manipulation of another person can be recognized by the report.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

As above, the embodiment has been described as an example of the technology disclosed in the present application. However, the technology in the present disclosure is not limited to this and is also applicable to embodiments in which modifications, replacements, additions, omissions and the like are suitably made. Moreover, a new embodiment may be prepared by combining the components described in the above embodiment. For example, some of components or methods in an embodiment may be applied to another embodiment, and some of components in an embodiment may be separated and arbitrarily extracted from the other components in the embodiment. Furthermore, the components shown in the attached drawings and the detailed explanations include not only components essential to solve the problems but also components for exemplifying the above technology and not essential to solve the problems.

What is claimed is:

1. A system comprising processing circuitry,
the processing circuitry being configured to:
generate traveling history data based on positional information indicating a position of a personal watercraft, the traveling history data including information indicating a movement route of the personal watercraft; and
output the traveling history data.

2. The system according to claim 1, wherein the traveling history data includes identification information associated with the personal watercraft.

3. The system according to claim 1, wherein the traveling history data includes time period information regarding a time period in which the personal watercraft has moved along the movement route.

4. The system according to claim 1, wherein:
outputting the traveling history data includes transmitting the traveling history data to a server;
the server stores pieces of traveling history data including the traveling history data; and
the processing circuitry is further configured to
transmit a request signal to the server in accordance with a visual output request,
receive at least one piece of specific traveling history data that is at least one of the pieces of traveling history data from the server, and
make a visual output device visually output the specific traveling history data.

5. The system according to claim 4, wherein:
the at least one piece of specific traveling history data includes pieces of specific traveling history data; and
making the visual output device visually output the specific traveling history data includes making the visual output device visually output superimposed display of the pieces of specific traveling history data.

6. The system according to claim 4, wherein:
the processing circuitry is further configured to receive a user's input of registering one or more other personal watercrafts as specific personal watercrafts in a group; and
the visual output request includes a request of making the visual output device visually output the traveling history data corresponding to the specific personal watercrafts belonging to the group.

7. The system according to claim 1, wherein:
the processing circuitry is further configured to receive an input of additional information associated with a specific location in the movement route; and
the traveling history data includes the additional information.

8. The system according to claim 1, wherein:
the processing circuitry is further configured to receive an input of marking information associated with a specific location in the movement route; and
the traveling history data includes the marking information.

9. The system according to claim 1, wherein:
the processing circuitry is further configured to receive an input of image information associated with the movement route; and
the traveling history data includes the image information.

10. The system according to claim 1, wherein the processing circuitry is further configured to generate, based on the traveling history data, a control signal which makes the personal watercraft automatically travel along the movement route.

11. The system according to claim 1, wherein the traveling history data includes behavior information indicating behavior of the personal watercraft.

12. The system according to claim 1, wherein the behavior information includes information indicating a speed of the personal watercraft or a posture of the personal watercraft.

13. The system according to claim 1, wherein the traveling history data includes information indicating a manipulation amount regarding driving manipulation of a user.

14. A server comprising processing circuitry,
the processing circuitry being configured to:
store pieces of traveling history data respectively including pieces of information indicating movement routes of personal watercrafts;
receive a request signal; and
transmit the pieces of traveling history data in accordance with the request signal to make a visual output device visually output superimposed display of the pieces of specific traveling history data.

15. A method comprising:
generating traveling history data by processing circuitry based on positional information indicating a position of a personal watercraft, the traveling history data including information indicating a movement route of the personal watercraft; and
outputting the traveling history data by the processing circuitry.
